(19) United States
(12) Patent Application Publication
(10) Pub. No.: US 2026/0245075 A1
(43) Pub. Date: Aug. 20, 2026

(54) Quantum-Safe Crypto Currency System

(71) Applicants: Adam Denoto, Brook Park, OH (US); Jack Gilchrist, Brook Park, OH (US)

(72) Inventors: Adam Denoto, Brook Park, OH (US); Jack Gilchrist, Brook Park, OH (US)

(21) Appl. No.: 19/456,050

(22) Filed: Jan. 22, 2026

Related U.S. Application Data
(60) Provisional application No. 63/759,584, filed on Feb. 18, 2025.

(51) Int. Cl. G06Q 20/36; G06Q 20/40; H04L 9/32

(52) U.S. Cl. CPC G06Q 20/3678; G06Q 20/4016; H04L 9/3218; G06Q 2220/00

(57) ABSTRACT

A quantum-safe digital currency system designed to resist security threats posed by quantum computing is disclosed. The system includes a quantum-resilient blockchain module that utilizes hash-based post-quantum digital signature algorithms, such as the eXtended Merkle Signature Scheme (XMSS), to generate and verify quantum-secure transactions while maintaining a fixed supply of cryptocurrency tokens. A scam recovery and reporting module employs artificial intelligence and a decentralized encrypted interface to detect and report fraudulent activities. An arbitration module, operating within a decentralized autonomous organization (DAO), enables validator nodes to perform quantum-secure voting and verification to authorize fund reversals. A transaction security module applies zero-knowledge proofs (ZKPs) and quantum-secure communication channels to ensure privacy and authenticity. When a scam is verified, a multi- signature quantum-secure reversal transaction restores assets to their rightful owner.

### CROSS-REFERENCE TO RELATED APPLICATION

The present application claims priority to, and the benefit of, U.S. Provisional Application No. 63/759,584 which was filed on February 18, 2025, and is incorporated herein by reference in its entirety.

### FIELD OF THE INVENTION

The present invention generally relates to cryptocurrency security systems and blockchain-based digital financial technologies. More specifically, the present invention relates to a quantum-safe digital currency system designed to provide enhanced resistance to quantum computing-based attacks while enabling decentralized fraud detection, reporting, and recovery. The invention comprises a multi-module cryptocurrency architecture that includes a quantum- resilient blockchain module configured to maintain a distributed ledger of transactions using hash- based post-quantum cryptographic algorithms, such as the eXtended Merkle Signature Scheme (XMSS), to generate and verify quantum-secure digital signatures. The system further includes a scam recovery and reporting module equipped with a decentralized reporting interface for encrypted user submissions of fraudulent activity, and an arbitration module operating within a decentralized autonomous organization (DAO) framework to enable validator nodes to perform quantum-secure voting for dispute resolution. Additionally, a transaction security module employs zero-knowledge proofs (ZKPs) and quantum-secure communication protocols to validate and protect transactions without revealing sensitive information. Accordingly, the present disclosure makes specific reference thereto. Nonetheless, it is to be appreciated that aspects of the present invention are also equally applicable to other like applications, devices, and methods of manufacture.

### BACKGROUND

By way of background, trading or investing in cryptocurrencies presents persistent risks of fraud and financial loss due to the largely unregulated nature of digital currencies. Traditional cryptocurrencies, while decentralized, lack a unified oversight mechanism capable of monitoring or reversing fraudulent transactions. As a result, when scams or unauthorized transfers occur, recovery of lost assets often relies solely on voluntary community action rather than formal institutional intervention.

Moreover, most existing cryptocurrencies are not equipped to defend against emerging quantum computing threats. Quantum computers, with their superior computational capacity, have the potential to break existing cryptographic standards such as elliptic curve and RSA-based encryption. This vulnerability could expose private keys, transaction histories, and sensitive user data to malicious actors, undermining the foundation of blockchain security. Accordingly, individuals desire a quantum-resilient cryptocurrency system which can prevent quantum decryption attacks.

Therefore, there exists a long-felt need in the art for an improved quantum-safe cryptocurrency system that overcomes the limitations of existing blockchain technologies, which remain vulnerable to potential attacks from quantum computing. There is a need for a digital currency infrastructure that maintains long-term cryptographic integrity through the use of post- quantum security mechanisms. Furthermore, there is a need for a cryptocurrency that incorporates community-based fraud detection and recovery tools, enabling users to report, track, and resolve scam-related activities through decentralized arbitration. Additionally, there exists a need for a system that provides transaction privacy through zero-knowledge validation. Finally, there is a need for a cryptocurrency architecture that preserves value stability by enforcing a fixed supply model, thereby preventing inflation and protecting users' digital assets.

The subject matter disclosed and claimed herein, in one embodiment, comprises a quantum-safe digital currency system designed to provide a secure, transparent, and resilient cryptocurrency framework capable of withstanding future quantum computational threats. The system includes a quantum-resilient blockchain module configured to maintain the distributed ledger and manage all transaction validations using hash-based post-quantum cryptographic algorithms, such as the eXtended Merkle Signature Scheme (XMSS). The module digitally signs every transaction with a quantum-resistant key pair and records immutably in the blockchain ledger. The blockchain module further enforces a fixed coin supply such as a total of approximately 5.25 million coins, to maintain scarcity and intrinsic value protection.

In one embodiment, the system also features a scam recovery and reporting module configured to detect, report, and manage fraudulent transactions. The module provides a decentralized user interface through which users can submit encrypted reports of suspicious activity. The reports are evaluated by an arbitration module that operates within a decentralized autonomous organization (DAO) framework, enabling a plurality of trusted validator nodes to review and verify the legitimacy of claims through quantum-secure voting mechanisms. Upon verification, the arbitration module initiates a multi-signature quantum-secure recovery transaction, returning affected funds to the rightful owner.

In this manner, the quantum-safe digital currency system of the present invention overcomes the longstanding deficiencies in conventional cryptocurrencies by providing a comprehensive, quantum-resilient, and user-protective framework. The invention not only addresses the emerging threat posed by quantum computing but also introduces a community- driven scam recovery architecture that promotes fairness and accountability. The integration of XMSS-based digital signatures, zero-knowledge proofs, and DAO-governed arbitration provides a balance between security, transparency, and privacy. Furthermore, the fixed coin supply model preserves economic stability, while the decentralized structure eliminates reliance on centralized authorities. The system provides a next-generation cryptocurrency platform that maintains transactional integrity, prevents fraud, and safeguards user assets in both classical and post- quantum computing environments.

### SUMMARY OF THEINVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a quantum-safe digital currency system that is resistant to quantum computing-based attacks. The system includes a quantum-resilient blockchain module that maintains a distributed ledger for all cryptocurrency transactions and utilizes a hash-based post-quantum digital signature algorithm, such as the eXtended Merkle Signature Scheme (XMSS), to generate and verify quantum-safe signatures. The blockchain module maintains a fixed cryptocurrency supply cap of about 5.25 million coins to preserve value scarcity. The system also incorporates a scam recovery and reporting module configured to detect, report, and mitigate fraudulent or suspicious activities using artificial intelligence trained on fraudulent transaction patterns. A decentralized arbitration module operating within a decentralized autonomous organization (DAO) framework enables validator nodes to perform quantum-secure voting and verification to adjudicate scam reports. Additionally, a transaction security module provides privacy and authentication through zero-knowledge proofs (ZKPs) and quantum-secure communication channels. When a fraud claim is validated, a multi- signature quantum-secure reversal transaction restores the affected funds, and the transaction is permanently recorded on the blockchain ledger.

In another embodiment, a method for managing quantum-resilient cryptocurrency transactions in a decentralized environment is described. The method includes initializing a cryptocurrency transaction via a secure wallet interface and signing the transaction using a post- quantum cryptographic algorithm, such as XMSS, which provides a one-time, quantum-resistant digital signature. The transaction is then verified by validating the XMSS public key and hash chain, after which it is encrypted and stored immutably within the blockchain. If an unauthorized or suspicious transaction is detected, a user may submit an encrypted scam report through the scam recovery and reporting module, linking the report to the relevant blockchain entry. The arbitration module, operating within a DAO governance framework, receives and evaluates the report through quantum-secure voting and verification conducted by validator nodes. Upon consensus, a multi- signature quantum-secure reversal transaction is executed to return funds to the rightful owner, and the verified reversal is permanently recorded on the blockchain ledger to maintain transactional integrity.

In yet another embodiment, a decentralized arbitration framework that enables community-based governance for quantum-resilient cryptocurrency systems is disclosed. The framework includes a network of trusted validator nodes organized as a decentralized autonomous organization (DAO) responsible for reviewing scam reports and disputes. An arbitration module receives encrypted scam reports, initiates quantum-secure voting and verification among validator nodes and determines by consensus whether a transaction qualifies for reversal or compensation. Upon approval, a multi-signature recovery mechanism is activated, requiring a threshold number of validator nodes to co-sign a quantum-secure reversal transaction. The reversal is executed by a transaction security module.

In yet another embodiment, the invention provides a scam recovery and reporting interface that enables users to securely report and track incidents of fraudulent or unauthorized cryptocurrency transactions. The interface includes a transaction identification field for entering a unique transaction identifier linked to a blockchain record, a description field for inputting details of the fraudulent activity, and a category selection field for classifying the report into categories such as suspicious activity, phishing, unauthorized transfer, or scam purchase. A submit report function encrypts the entered data using quantum-resistant encryption algorithms and transmits the report to the decentralized network for evaluation. The interface further includes a reported cases section that enables users to view the status of their reports, including options such as "All Reports," "Under Review," and "Resolved.".

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an architectural block diagram of quantum-safe digital currency system of the preset invention in accordance with the disclosed structure;

FIG. 2 illustrates a flow diagram representing the operational process for managing a secure, quantum-resilient cryptocurrency transaction and scam recovery procedure, in accordance with one embodiment of the invention;

FIG. 3 illustrates an exemplary flow diagram depicting the security process implemented by the quantum-resilient crypto system for protecting transactions against quantum computing-based attacks in accordance with the disclosed architecture; and

FIG. 4 illustrates an exemplary scam recovery and reporting interface implemented within the Quantanium Coin (QTC) quantum-resilient crypto system of the present invention in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved quantum-safe cryptocurrency system that overcomes the limitations of existing blockchain technologies, which remain vulnerable to potential attacks from quantum computing. There is a need for a digital currency infrastructure that maintains long-term cryptographic integrity through the use of post- quantum security mechanisms. Furthermore, there is a need for a cryptocurrency that incorporates community-based fraud detection and recovery tools, enabling users to report, track, and resolve scam-related activities through decentralized arbitration. Additionally, there exists a need for a system that provides transaction privacy through zero-knowledge validation. Finally, there is a need for a cryptocurrency architecture that preserves value stability by enforcing a fixed supply model, thereby preventing inflation and protecting users' digital assets.

The present invention, in one exemplary embodiment, is a method for managing quantum-resilient cryptocurrency transactions in a decentralized environment. The method includes initializing a cryptocurrency transaction via a secure wallet interface and signing the transaction using a post-quantum cryptographic algorithm, such as XMSS, which provides a one- time, quantum-resistant digital signature. The transaction is then verified by validating the XMSS public key and hash chain, after which it is encrypted and stored immutably within the blockchain. If an unauthorized or suspicious transaction is detected, a user may submit an encrypted scam report through the scam recovery and reporting module, linking the report to the relevant blockchain entry. The arbitration module, operating within a DAO governance framework, receives and evaluates the report through quantum-secure voting and verification conducted by validator nodes. Upon consensus, a multi-signature quantum-secure reversal transaction is executed to return funds to the rightful owner, and the verified reversal is permanently recorded on the blockchain ledger to maintain transactional integrity.

Reference will now be made in detail to the present preferred embodiments of the invention, examples of which are illustrated in the accompanying drawings. Wherever possible, the same reference numerals are used in the drawings and the description to refer to the same or like parts.

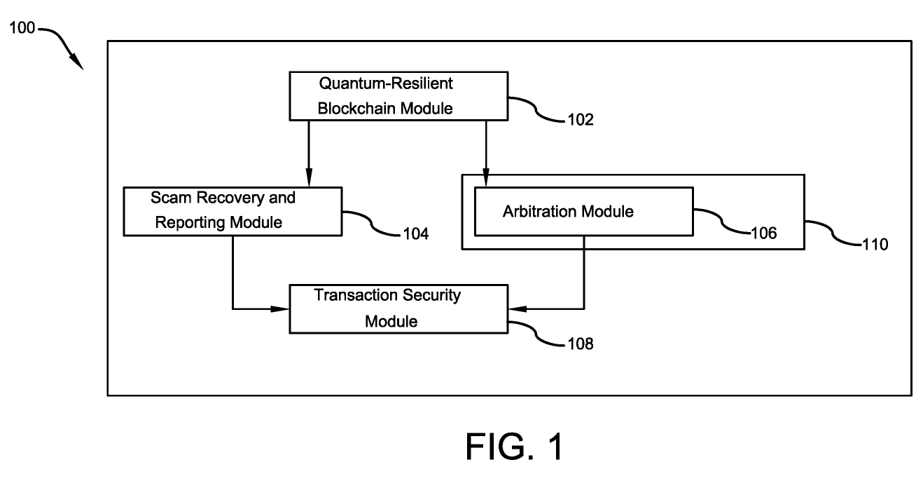

Referring initially to the drawings, FIG. 1 illustrates an architectural block diagram of quantum-safe digital currency system of the preset invention in accordance with the disclosed structure. The quantum-safe digital currency system 100 of the present invention is designed to be resilient to quantum computing threats. More specifically, the quantum-safe digital currency system 100 includes a quantum-resilient blockchain module 102 which is configured to maintain the distributed ledger of the cryptocurrency transactions and governs the validation and storage of all cryptocurrency transactions.

The quantum-resilient blockchain module 102 preferably utilizes eXtended Merkle Signature Scheme (XMSS) or equivalent hash-based post-quantum digital signature algorithms to protect against decryption by quantum computers. The module 102 generates and verifies quantum-safe signatures to ensure that transactions are not forged or tampered with by entities using advanced computational methods. Additionally, the module 102 maintains a predetermined fixed coin supply of cap coins such as about 5.25 million cryptocurrency tokens, providing an inherent value preservation mechanism.

A scam recovery and reporting module 104 is configured for detecting, reporting, and mitigating fraudulent or suspicious transactions. The module 104 provides a decentralized reporting interface (scam recovery and reporting interface) that enables users to securely submit scam reports wherein each report is recorded in encrypted form and associated with the corresponding transaction on the blockchain ledger.

The module 104 utilizes artificial intelligence and is trained in fraudulent transactions conditions and scenarios. The module 104 is adapted to automatically (i.e., autonomously) flag suspicious patterns, consolidate community reports, and relay relevant transaction data to an arbitration module 106 for review.

The arbitration module 106 is configured to perform decentralized dispute resolution and community-driven governance functions in the system 100. The module 106 preferably operates within a decentralized framework 110 (decentralized autonomous organization/ framework (DAO)) and enables a plurality of trusted validator nodes included in the decentralized autonomous organization 110 to participate in the evaluation of reported scams. Each arbitration event can involve quantum-secure voting and verification processes that determine whether a reported transaction qualifies for reversal or compensation.

The arbitration module 106 communicates directly with both the scam recovery and reporting module 104 and the transaction security module 108. Upon reaching a consensus, and if the scam claim is verified, the module 106 initiates a multi-signature quantum-secure transaction that authorizes the reversal of funds, thereby restoring assets to the rightful owner.

The transaction security module 108 provides the confidentiality, privacy, and authenticity of all cryptocurrency transactions. Further, the module 108 employs zero-knowledge proofs (ZKPs) to validate transactions without exposing sensitive user information, such as wallet addresses or transaction values. The module 108 establishes quantum-safe communication channels to execute verified transactions and implements quantum-resistant encryption algorithms to protect against eavesdropping and decryption attempts.

The transaction security module 108 processes arbitration results received from the arbitration module 106 and finalizes either the transaction confirmation or reversal process. Upon completion, the module 108 transmits the cryptographically verified transaction record back to the quantum-resilient blockchain module 102 for permanent inclusion in the ledger.

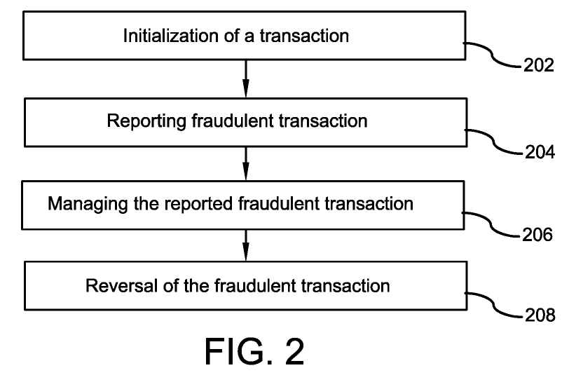

FIG. 2 illustrates a flow diagram representing the operational process for managing a secure, quantum-resilient cryptocurrency transaction and scam recovery procedure, in accordance with one embodiment of the invention. Initially, a user initiates a cryptocurrency transaction through a quantum-resilient wallet or network interface (Step 202). The transaction is digitally signed using a post-quantum cryptographic algorithm, such as the eXtended Merkle Signature Scheme (XMSS), such that the transaction remains secure against quantum computational attacks. The signed transaction is then transmitted to the blockchain network, where it undergoes validation by the quantum-resilient blockchain module 102. Upon successful verification, the transaction is recorded immutably on the distributed ledger.

At step 204, if a user detects an unauthorized or suspicious transaction, the user can submit a report through a scam recovery and reporting interface integrated into the system. The report can include transaction details, relevant evidence, and user credentials, which are encrypted using quantum-safe encryption mechanisms. The report may also be stored for transparency and immutability.

At step 206, the process advances to managing the reported fraudulent transaction. The arbitration module 106 which functions under a decentralized autonomous organization/ framework (DAO) governance model, receives the report and initiates an evaluation process. The validator nodes of the framework review the transaction details and verify the authenticity of the fraud claim using quantum-secure voting and verification protocols. The evaluation is performed in a decentralized manner and accordingly, the arbitration module authorizes a recovery operation by communicating with the transaction security module 108.

Finally, at step 208, reversal of the fraudulent transaction is performed. Upon approval from the arbitration module 106, the transaction security module 108 executes a multi-signature quantum-secure transaction to restore the affected funds to their owner. A plurality of trusted DAO nodes approve and co-sign the reversal transaction to eliminate the risk of unauthorized manipulation. The quantum-resilient blockchain module 102 updates the ledger to reflect the reversal for updating and maintaining ledger integrity.

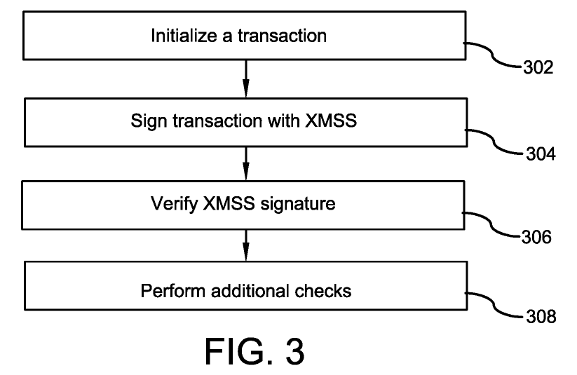

FIG. 3 illustrates an exemplary flow diagram depicting the security process implemented by the quantum-resilient crypto system for protecting transactions against quantum computing-based attacks in accordance with the disclosed architecture. Initially, a transaction is initialized by a user through a wallet interface or network node (Step 302). The transaction details, including sender and recipient addresses, amount, and timestamp, are used for digital signing of the transaction. The system 100 can use a quantum-safe hash-based cryptographic environment to generate unique identifiers and transaction hashes for the transaction.

Then, the transaction is signed with XMSS (eXtended Merkle Signature Scheme) (Step 304). XMSS is a hash-based post-quantum signature algorithm that provides forward security and resistance to quantum computational attacks such as Shor's algorithm. Each transaction is signed with a one-time XMSS key, so that even if one signature key were exposed affecting a transaction, other transactions of the system 100 remain secure.

Thereafter, the system 100 executes verification of the XMSS signature (Step 306). During the verification stage, the network nodes implementing the system validate the transaction by confirming the integrity of the XMSS public key and corresponding hash chains.

At step 308, the process includes performing additional checks. The system 100 implements various layers of post-quantum cryptographic mechanisms, including but not limited to Zero-Knowledge Proofs (ZKPs) and quantum-secure communication channels. The ZKPs enable transaction validation without revealing confidential details, while quantum-secure channels protect the integrity of communication between nodes.

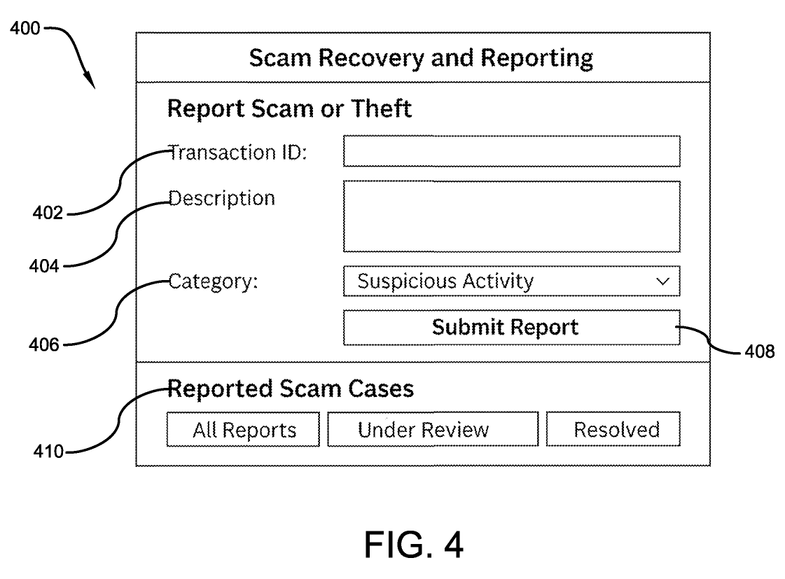

FIG. 4 illustrates an exemplary scam recovery and reporting interface implemented within the Quantanium Coin (QTC) quantum-resilient crypto system of the present invention in accordance with one embodiment of the present invention. The interface 400 provides a user- accessible graphical interface/dashboard through which users can report, track, and manage incidents of suspected fraudulent or unauthorized transactions within the decentralized, quantum- resilient cryptocurrency network.

The interface 400 provides a transaction ID field 402 that enables a user to enter a unique identifier corresponding to the fraudulent transaction. The transaction ID field 402 links the report to a specific blockchain record, enabling the system 100 to cross-reference the transaction with the immutable ledger data stored within the quantum-resilient blockchain module.

A description field 404 permits users to input a textual explanation of the suspicious event or theft, including relevant contextual details such as date, nature of activity, and any associated wallet information. The description data assists the arbitration and validation processes carried out by decentralized validator nodes for determining the fraud/scam.

A category field 406 enables the user to classify the nature of the report by selecting from predefined categories such as "Suspicious Activity," "Phishing," "Unauthorized Transfer," or "Scam Purchase." Categorization supports automated prioritization and routing of reports within the decentralized network, enabling the system to efficiently allocate arbitration resources and perform threat pattern analysis.

A submit report button 408 is provided to submit the report. Upon activation, the system encrypts the entered information using quantum-resistant encryption algorithms and forwards the report to the decentralized network for validation.

The lower portion of the interface 400 includes a reported scam cases section 410, which enables users to monitor the status of their submitted reports. The section includes selectable filters labeled "All Reports," "Under Review," and "Resolved." The filters provide users with an overview of their report statuses within the scam recovery dashboard 400. The "Under Review" state indicates that the report is being evaluated by the arbitration module, while the "Resolved" state confirms that the arbitration process has been completed.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein "quantum-safe digital currency system", "quantanium coin (qtc) quantum-resilient crypto system", "quantum-resilient crypto system", and "system" are interchangeable and refer to the quantum-safe crypto currency system 100 of the present invention.

Notwithstanding the forgoing, the quantum-safe crypto currency system 100 of the present invention can be of any suitable configuration as is known in the art without affecting the overall concept of the invention, provided that it accomplishes the above stated objectives. One of ordinary skill in the art will appreciate that the quantum-safe crypto currency system 100 shown in the FIGS. are for illustrative purposes only, and that many other configurations of the quantum- safe crypto currency system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term "includes" is used in either the detailed description or the claims, such term is intended to be inclusive in a manner similar to the term "comprising" as "comprising" is interpreted when employed as a transitional word in a claim.

What is claimed is:

1. A quantum-safe digital currency system comprising:
a quantum-resilient blockchain module;
a reporting module;
an arbitration module; and
a transaction security module;
wherein said quantum-resilient blockchain module is configured to maintain a distributed blockchain ledger of cryptocurrency transactions;
wherein said quantum-resilient blockchain module generates quantum-safe signatures to prevent fraudulent said cryptocurrency transactions;
wherein said reporting module comprises a decentralized reporting interface configured to securely submit scam reports wherein each report is recorded in encrypted form and associated with a corresponding said fraudulent said cryptocurrency transaction on said blockchain ledger;
wherein said arbitration module is configured to perform decentralized dispute resolution in the quantum-safe digital currency system; and
further wherein said transaction security module employs zero-knowledge proofs (ZKPs) to validate transactions.

2. The quantum-safe digital currency system of claim 1, wherein said reporting module comprises artificial intelligence configured to detect said fraudulent said cryptocurrency transactions.

3. The quantum-safe digital currency system of claim 2, wherein said quantum-resilient blockchain module comprises a predetermined fixed coin supply of cap coins to provide an inherent value preservation mechanism.

4. The quantum-safe digital currency system of claim 3, wherein said reporting module is configured to autonomously flag said fraudulent said cryptocurrency transactions and relay transaction data to said arbitration module.

5. The quantum-safe digital currency system of claim 4, wherein said arbitration module operates within a DAO framework configured to reverse said fraudulent said cryptocurrency transactions.

6. The quantum-safe digital currency system of claim 5, wherein said arbitration module connected with said reporting module and said transaction security module and upon verifying said fraudulent said cryptocurrency transaction, said arbitration module initiates a multi-signature quantum-secure transaction that authorizes the reversal of funds associated with said fraudulent said cryptocurrency transaction.

7. The quantum-safe digital currency system of claim 6, wherein said transaction security module configured to establish quantum-safe communication channels to execute verified said cryptocurrency transactions.

8. The quantum-safe digital currency system of claim 7, wherein said transaction security module processes arbitration results received from said arbitration module and alternatively executes said verified said cryptocurrency transactions or reverses said fraudulent said cryptocurrency transactions.

9. The quantum-safe digital currency system of claim 8, wherein said transaction security module transmits the cryptographically verified transaction record back to said quantum-resilient blockchain module for inclusion in said blockchain ledger.

10. The quantum-safe digital currency system of claim 9, wherein said quantum-resilient blockchain module comprises a decryption security algorithm selected from the group consisting of eXtended Merkle Signature Scheme (XMSS) and a hash-based post-quantum digital signature.

11. A method of managing cryptocurrency transactions, the method comprising the steps of:
providing a quantum-resilient blockchain module, a reporting module, an arbitration module, and a transaction security module, wherein said quantum-resilient blockchain module is configured to maintain a distributed blockchain ledger of cryptocurrency transactions;
generating quantum-safe signatures with said quantum-resilient blockchain module to prevent fraudulent said cryptocurrency transactions, wherein said reporting module comprises a decentralized reporting interface configured to securely submit scam reports wherein each report is recorded in encrypted form and associated with a corresponding said fraudulent said cryptocurrency transaction on said blockchain ledger;
detecting said fraudulent said cryptocurrency transactions with said reporting module;
performing decentralized dispute resolution with said arbitration module in the quantum- safe digital currency system; and
employing zero-knowledge proofs (ZKPs) with said transaction security module to validate said cryptocurrency transactions.

12. The method of managing cryptocurrency transactions of claim 11, wherein said quantum- resilient blockchain module comprises a predetermined fixed coin supply of cap coins to provide an inherent value preservation mechanism.

13. The method of managing cryptocurrency transactions of claim 12, wherein said reporting module is configured to autonomously flag said fraudulent said cryptocurrency transactions and relay transaction data to said arbitration module.

14. The method of managing cryptocurrency transactions of claim 13, wherein said arbitration module operates within a DAO framework configured to reverse said fraudulent said cryptocurrency transactions.

15. The method of managing cryptocurrency transactions of claim 14 further comprising a step of connecting said arbitration module with said reporting module and said transaction security module, and upon verifying said fraudulent said cryptocurrency transaction, said arbitration
module initiates a multi-signature quantum-secure transaction that authorizes the reversal of funds associated with said fraudulent said cryptocurrency transaction.

16. The method of managing cryptocurrency transactions of claim 15, wherein said transaction security module configured to establish quantum-safe communication channels to execute verified said cryptocurrency transactions.

17. The method of managing cryptocurrency transactions of claim 16, wherein said transaction security module processes arbitration results received from said arbitration module and alternatively executes said verified said cryptocurrency transactions or reverses said fraudulent said cryptocurrency transactions.

18. The method of managing cryptocurrency transactions of claim 17, wherein said transaction security module transmits said verified said cryptocurrency transactions back to said quantum- resilient blockchain module for inclusion in said blockchain ledger.

19. The method of managing cryptocurrency transactions of claim 18, wherein said quantum- resilient blockchain module comprises a decryption security algorithm selected from the group consisting of eXtended Merkle Signature Scheme (XMSS) and a hash-based post-quantum digital signature.

20. A method of protecting cryptocurrency transactions, the method comprising the steps of:
providing a quantum-resilient blockchain module, a reporting module, and an arbitration module, wherein said quantum-resilient blockchain module is configured to maintain a distributed blockchain ledger of cryptocurrency transactions;
initializing said cryptocurrency transactions;
signing said cryptocurrency transactions with a XMSS;
generating quantum-safe signatures with said quantum-resilient blockchain module to prevent fraudulent said cryptocurrency transactions, wherein said reporting module comprises a decentralized reporting interface configured to securely submit scam reports wherein each report
is recorded in encrypted form and associated with a corresponding said fraudulent said cryptocurrency transaction on said blockchain ledger;
detecting said fraudulent said cryptocurrency transaction with said reporting module;
performing decentralized dispute resolution with said arbitration module in the quantum- safe digital currency system; and
connecting said arbitration module with said reporting module, and upon verifying said fraudulent said cryptocurrency transaction, said arbitration module initiates a multi-signature quantum-secure transaction that authorizes the reversal of funds associated with said fraudulent said cryptocurrency transaction.
